(19) United States
(12) Patent Application Publication
(10) Pub. No.: US 2024/0137712 A1
(43) Pub. Date: Apr. 25, 2024

(54) SYSTEM, DEVICE AND METHOD OF SIGNAL CONDITIONING FOR EARPIECE CALIBRATION

(71) Applicant: ECOLE DE TECHNOLOGIE SUPERIEURE (ETS), Montreal, QC (CA)

(72) Inventors: Vincent Nadon, Montreal, QC (CA); Jeremie Voix, Montreal, QC (CA); Elliot Drees, Montreal, QC (CA)

(21) Appl. No.: 18/554,347

(22) PCT Filed: Apr. 6, 2022
(86) PCT No.: PCT/CA2022/050522

§ 371 Date: Oct. 6, 2023

Related U.S. Application Data
(60) Provisional application No. 63/171,147, filed on Apr. 6, 2021.

(51) Int. Cl. H04R 25/00

(52) U.S. Cl. CPC H04R 25/30

(57) ABSTRACT

A system, device and method to condition a wide-band calibration stimulus such as a chirp or logarithmic chirp with the purpose of reducing the dynamic range necessary for an acquisition system of an audio wearable device. The dynamic range of the stimulus is compressed using a temporal envelope and digital filters to prevent the high magnitude of the resonance peaks from clipping or saturating the response signal. Such pre-conditioning method for the calibration of the audio wearable device may allow the use of a low -depth or low-resolution acquisition system to perform the measurements.

### CROSS-REFERENCE TO RELATED APPLICATIONS

The present patent application claims the benefits of priority of the U.S. patent application Ser. No. 63/171,147, entitled “SYSTEM, DEVICE AND METHOD OF SIGNAL CONDITIONING FOR EARPIECE CALIBRATION” and filed the United States Patent Office on Apr. 6, 2021, the content of which is incorporated herein by reference.

### TECHNICAL FIELD

The present invention relates to systems, devices and methods of signal conditioning for earpiece calibration. More particularly, the present invention relates to systems, devices and methods to condition a wide-band calibration stimulus with the purpose of reducing the dynamic range necessary for an acquisition system.

### BACKGROUND ART

Despite efforts in hearing conservation programs, noise-induced hearing loss (NIHL) remains a major occupational problem due to excessive noise exposure in the workplace. As the loss of sound perception can potentially lead to communication problems, isolation and depression, it remains important to regularly assess the health of employees or workers and to conduct strict follow-ups.

Despite the effects of aging, recent studies show that noise exposure is the main risk factor with noise exposure at a young age being aggravated over time. Excessive noise exposure levels can damage the hair cells in the cochlea which is the organ responsible for the generation of electrical nerve signals resulting from acoustical stimulation. Measuring the general health of the cochlea's outer hair cells (OHC) is therefore one of the most accurate methods of evaluating an individual's general hearing health as it provides an objective measure. This method is particularly more reliable than conventional tests which rely on subjective responses of individuals when subjected to auditory stimuli. To determine the general health of the OHC, methods have been developed to measure the low amplitude acoustic signals known as otoacoustic emissions (OAE). These can be generated during a test when the cochlea is subjected to external stimuli generated by a miniature loudspeaker in the ear canal. For clinical applications, OAEs can be evoked by transmitting two pure-tone acoustic stimulation signals into the ear canal with miniature loudspeakers inside an earpiece.

Conventional OAE measurements are performed with a sensitive in-ear microphone positioned in the outer ear canal. These measurements are objective, fast and do not require the active participation of the test subject.

Monitoring OAE levels on an individual while being exposed to noise can additionally identify temporary hearing status changes induced by the exposure. While known OAE measurement techniques allow for reliable assessments of a worker's hearing health, conventional OAE measurement devices and their test duration do not allow for the continuous monitoring of accumulated hearing fatigue in an industrial workplace. Instead, workers are commonly subjected to occasional hearing tests whereby hearing damage is often identified once the damage is done and irreversible.

Earpieces for OAE measurements require precise calibration to compensate for the miniature loudspeakers response in the ear canal in order to obtain reliable absolute OAE levels with the designed earpieces. However, basic calibration methods do not compensate precisely for the difference in sound pressure between the position at the earpiece tip and the tympanic membrane, since all individuals have different ear canal shapes and the insertion depth of the earpiece varies.

A more elaborate calibration method using the Thevenin estimate of the miniature loudspeaker has been used for OAE stimuli calibration, however this method requires high-end hardware for the acquisition of the calibration signals in order to minimize the distortion for a precise Thevenin estimate.

Hence, there is a need for a cost-effective, practical and reliable OAE calibration method for a device to measure the necessary noise metrics and test hearing health on a short-time interval during the noise exposure for proper NIHL risk assessment.

### SUMMARY OF INVENTION

The shortcomings of the prior art are generally mitigated by a method to calibrate an earpiece, the method comprising calculating the Thevenin equivalent impedance of at least one loudspeaker, calculating the load impedance at a reference plane in the ear canal as a function of the estimated Thevenin equivalent impedance, estimating forward pressure (P_{forward}) emitted by the loudspeaker at the reference plane based on the calculated load impedance and on the measured sound pressure level, and calculating a correction value to be applied on the loudspeaker based on the estimated forward pressure level.

The calculation of the Thevenin equivalent may further comprise calculating the Thevenin equivalent impedance (Zₛ) and sound pressure (Pₛ) and the calculation of the load impedance may further comprise measuring a sound pressure (P₁) in the ear canal at the reference plane and calculating the impedance (Z₁) at the reference plane using the following equation:

$${Z}_{l} = \frac{{Z}_{s} {P}_{l}}{{P}_{s} - {P}_{l}} .$$

Similarly, the estimation of the estimated pressure level emitted by the loudspeaker may use the following equation:

$${P}_{forward} = \frac{1}{2} {P}_{l} ( 1 + \frac{{Z}_{0}}{{Z}_{l}} ) .$$

The calculation of the correction value to be applied on the loudspeaker may further comprise using a gain table and finding difference between a desired sound pressure level and the P_{forward} value at a specific frequency in the gain table.

In another aspect of the invention, a method to estimate the Thevenin equivalent of a loudspeaker is disclosed comprising using a calibration device having a cavity to measure sound pressure (P) at different frequencies, calculating an ideal expression of the cavity impedance (Z_{c}), and estimating the Thevenin equivalent based on the calculated ideal expression of the cavity impedance.

The calculation of the ideal expression of the cavity impedance (Z_{c}) may further comprise generating first and second stimulus signals with the first signal potentially being a sine wave signal, processing the first signal, pre-conditioning the second signal, alternatively emitting the first and second signals in a calibration tube of the calibration device, capturing the sound pressure in the calibration tube using an in-ear microphone (IEM) and estimating the sound pressure frequency response based on the captured IEM signal.

The processing of the first signal may further comprise synchronizing the acoustical and digital waveforms of the first signal, windowing the first signal with a first envelop and estimating the latency of the first signal.

Moreover, the second signal may be a logarithmic chirp signal or any wide-band stimulus signal and the pre-conditioning of the second signal may comprise filtering the second signal, applying one or two Infinite Impulse Response (IIR) notch filters in series on the second signal and windowing the second signal using a fade-in/fade-out function envelope over a first predetermined number of samples and a last predetermined number of samples of each cycle.

The method may further comprise performing temporal averaging of the second signal and the estimation of the sound pressure frequency response may comprise computing a Fast Fourier Transform (FFT) on the preprocessed (digital) signal sent to the loudspeakers and on the captured IEM signal and computing a ratio of the two computed FFTs using a transfer function.

In yet another aspect of the invention, a calibration device to estimate Thevenin equivalent of a loudspeaker is present. The calibration device comprises a loudspeaker being configured to generate two stimulus signals, a cavity having a variable volume, a capturing device to measure the sound pressure emitted by the loudspeaker in the cavity, a signal preprocessor connected to the loudspeaker, the signal processor being adapted to process the stimulus signals, a signal selector to emit one of the two stimulus signals in the cavity and a signal postprocessor connected to the capturing device and configured to estimate the cavity frequency response based on the captured sound pressure.

The calibration device may further comprise a slidable piston to vary the volume of the cavity. The capturing device may be an in-ear microphone and the preprocessor may comprise one or two Infinite Impulse Response (IIR) notch filters in series and be configured to filter the second stimulus signal.

The preprocessor may comprise a fade-in/fade-out function envelope over a first predetermined number of samples and a last predetermined number of samples of each cycle. The calibration device may further comprise a latency estimator connected to the preprocessed stimulus signal and to the captured signal and the postprocessor may be configured to compute a Fast Fourier Transform (FFT) on the preprocessed (digital) signal sent to the loudspeakers and on the captured IEM signal. The postprocessor may be configured to compute a ratio of the two computed FFTs using a transfer function estimation.

The cavity may be a metal tube potentially made of brass and the calibration device may comprise five (5) metal tubes having different lengths.

### BRIEF DESCRIPTION OF DRAWINGS

The above and other aspects, features and advantages of the invention will become more readily apparent from the following description, reference being made to the accompanying drawings in which:

FIG. 1 is an illustration of an embodiment of an audio wearable device having an earpiece according to the principles of the present invention, the earpiece being placed into an ear-canal entrance of a wearer.

FIG. 2 is an illustration of the audio wearable device of FIG. 1, the audio wearable device being shown with wave components, according to one embodiment.

FIG. 3 is an illustration of a Thevenin equivalent circuit representation of a loudspeaker of the audio wearable device of FIG. 1.

FIG. 4 is a block diagram of an embodiment of a method to calculate a correction value to apply to a loudspeaker sound pressure level according to the principles of the present invention.

FIG. 5 is a graph presenting magnitude (dB) of signals within the calibration device as a function of the frequency (Hz).

FIG. 6 is a photograph of a calibration device according to the principles of the present invention.

FIG. 7 is an illustration of the calibration device of FIG. 6, according to one embodiment.

FIG. 8 is a block diagram of a method for calibrating a signal emitted from an earpiece according to the principles of the present invention.

FIG. 9 is a schematic of a calibration pre-conditioning method for the stimuli generated in a calibration device to estimate a Thevenin equivalent of a loudspeaker according to the principles of the present invention.

FIG. 10 is a graph presenting magnitude (dB) of the captured response and of the emitted response, also referred to as the pre-conditioned signal, as a function of the frequency (Hz) according to the principles of the present invention.

FIG. 11 is a graph presenting magnitude (dB) of response signals captured and compensated using different calibration methods as a function of the frequency (Hz).

### DETAILED DESCRIPTION OF THE PREFERRED EMBODIMENT

A system, device and method for signal processing for an earpiece calibration will be described hereinafter. Although the system, device and method are described in terms of specific illustrative embodiments, it shall be understood that the embodiments described herein are by way of example only and that the scope of the device and method is not intended to be limited thereby.

The OAE response frequency is typically calculated based on the spectrum of a stimulus signal or using two pure-tone acoustic stimulation signals at frequenciesfi andfi.

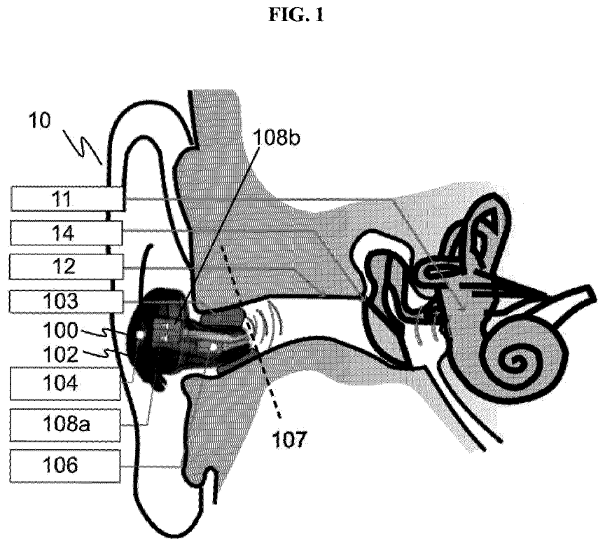

Within the ear 10, as shown in FIG. 1, the cochlea 11 serves to amplify and enhance captured sound for efficient decoding by the brain. In doing so however, the cochlea 11 produces its own physical vibrations along the basilar membrane of the inner ear (not shown). When the ear is presented with a certain stimulus however (such as two simultaneous pure-tone frequencies), the cochlea 11 may generate distortion product otoacoustic emissions (DPOAE). As the DPOAE travel from the cochlea 11 upwards of the basilar membrane, it may additionally travel in a reverse direction from the cochlea 11 and into the ear canal 12. The presence of DPOAE in the ear canal 12 indicates that the cochlea 11 (or more specifically the cochlear amplifier) is functioning properly. When the DPOAE is absent however, it may indicate that the cochlea 11 is non-functional or dysfunctional and that hearing loss may be occurring. In this way, a DPOAE produced by the cochlea 11 as a by-product and measured in the ear canal 12 is an effective means of identifying the integrity of the cochlea 11.

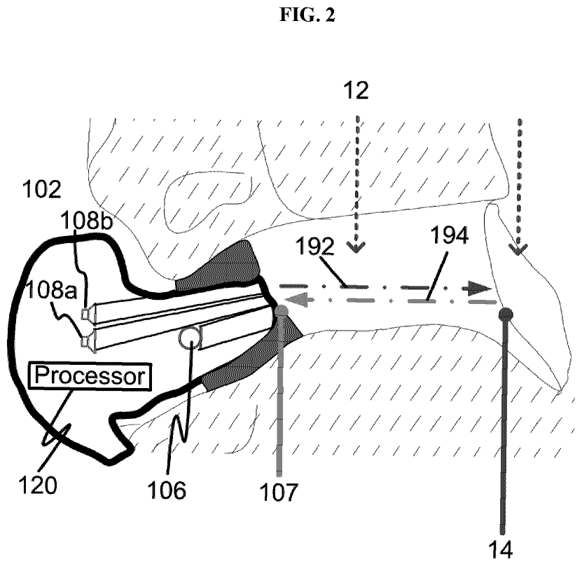

In prior art devices, an earpiece generally comprises a probe microphone to obtain direct measurements of OAE or DPOAE at the tympanic membrane 14. It may be appreciated that the earpiece 102 of the present invention does not require a probe positioned at the tympanic membrane 14 in order to obtain direct measurements of OAE or DPOAE generated thereby. Instead, a calibration of the earpiece 102 is performed in accordance with a geometry of the ear canal 12 to distinguish the forward pressure (consisting of the pressure wave component propagating away 192 from the earpiece 102) from the backwards traveling wave component 194 reflected from the tympanic membrane 14 as illustrated in FIG. 2.

Considering the various ear canal shapes (between-subject variations) and insertion depth of the earpiece (within-subject variations), the present calibration method generally aims at minimizing systematic differences in DPOAE levels.

Still referring to FIG. 1, an embodiment of a wearable device 100 comprising an earpiece is illustrated. The wearable device 100 is generally adapted to measure otoacoustic emissions (OAE) generated by the cochlea 11 and transmitted by the tympanic membrane 14. The wearable device 100 is disposed within an ear canal 12 of a user's ear 10. In this embodiment, the wearable device 100 comprises an earpiece 102 however, in other embodiments, the wearable device 100 may comprise an earplug, an intra-aural device or any other type of device adapted to prevent sounds or noises from accessing the auditory ear canal 12 of a user's ear 10. The earpiece 102 further comprises an external microphone (OEM) 104 and an internal microphone (IEM) 106 positioned and oriented to capture sounds outside and inside the ear canal 12, respectively.

In some embodiments, the external microphone (OEM) 104 is adapted to capture an outer-ear audio signal such as sounds or noises outside of the ear 10 or outside the ear canal 12, depending on the type of earpiece 102. The internal microphone (IEM) 106 is adapted to capture an inner-ear audio signal such as sounds or noises underneath or behind the earpiece 102 (inside the ear-canal), in the auditory ear canal 12 or ear cavity, depending on the type of earpiece 102.

In fact, the earpiece 102 generally acts as a sound barrier between the external microphone 104 and the internal microphone 106. In certain embodiments, the earpiece 102 may comprise an ear tip 103 configured to create a seal between the earpiece 102 and the ear canal 12. The ear tip 103 may be made of malleable plastic, rubber, foam or any other suitable material for creating sound isolation.

According to one embodiment, the wearable device 100 comprises two internal loudspeakers (SPK) (108a and 108b) positioned to emit the pure-tone stimulation signals in the ear canal at known frequencies f₁ and f₂. After the pure-tone stimulation signals pass through the external ear, the tympanic membrane 14 transmits the vibrations to the cochlea 11 by the ossicles. The cochlea 11 then amplifies the sounds to send the amplified stimulation signals to the brain through the auditory nerve. The f₁ and f₂ stimuli are amplified and/or compressed by the non-linear cochlear amplification process and result in distortion products, i.e. the OAE. The OAE is captured by the IEM 106. The distortion product frequencies are typically at f_{dp}, =[2f₁−f₁, 2f₂−f₁, 3f₁−2f₂, 3f₂−2f₁, 4f₁−3f₂, . . . ]. Understandably, as any other kinds of distortion products most of the energy is generally concentrated in the first distortion product, which is f_{dp}=2f₁−f₁. Prior art has shown that a f₂/f₁=1.22 ratio between the two stimuli frequency tends to give an optimal DPOAE level for the majority of the frequency spectrum, but a variable ratio depending on the testedfi frequency can give better results.

One or both of the internal loudspeakers 108a, 108b may be connected to a sound source (not shown). The IEM 106 is positioned to capture a sound wave signal (i.e. otoacoustic emissions primary tones) generated inside the ear canal according to the stimuli generated by the internal loudspeakers 108a and 108b. It shall be recognized that the signal generated inside the ear canal 12 includes the stimuli and the OAE generated by the cochlea 11 of the ear 10 in response to the stimuli. The characteristics of the reflected sound signal typically depends on the shape and volume of the ear canal 12, the earpiece 102 acoustics and the earpiece 102 seal quality.

Referring now to FIG. 2, wave components propagating in an ear using the wearable device 100 is illustrated. The total sound pressure level measured at the IEM comprises the forward pressure which itself comprises the wave component 192 propagating away from the sound source and the backwards traveling wave component 194 reflected from the eardrum.

The process of estimating the forward pressure component 200 generally aims at providing a personalized calibration of the stimuli levels equivalent to measuring the sound pressure level at the eardrum position (SPLterminal). The SPLentrance is the sound pressure level measured at the reference plane 107 in the ear canal 12 or the entrance of the cavity measured with the earpiece IEM 106. The FPL can be estimated from the IEM 106 at the reference plane 107 in the ear canal.

Estimating the forward pressure, by means of a forward pressure level (FPL) calibration process, tends to provide a more accurate estimate of the stimuli levels at the eardrum than a basic sound pressure level compensation. This calibration may reduce measurement errors due to the phase interference of standing waves between the wave components 192 and 194. In turn, a more accurate calibration process improves the accuracy of absolute DPOAE levels at higher frequencies. The FPL is an estimate of the emitted pressure level component of a sound source without the reflected pressure level component.

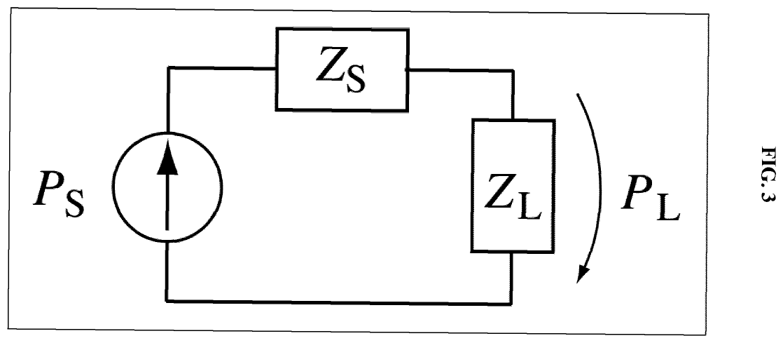

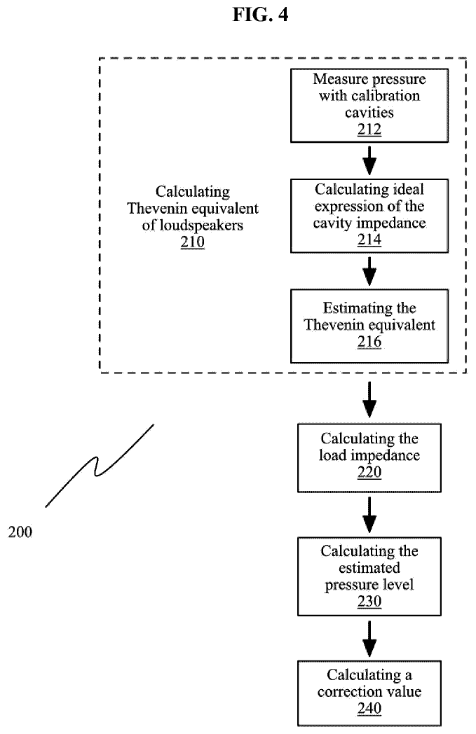

Referring now to FIGS. 3 and 4, the method to estimate the FPL component 200 comprises calculating the Thevenin equivalent of the loudspeakers (108a and 108b) 210, calculating the load impedance Z₁ as a function of the estimated Thevenin equivalent impedance Zₛ 220, calculating the estimated pressure level emitted by the loudspeaker 108 in the ear canal 12 (P_{forward}) 230 and calculating a correction value 240 to be applied on the loudspeaker 108. In the Thevenin equivalent circuit of FIG. 3, Zₛ is the impedance of the loudspeaker (108a or 108b), Ps is the sound pressure term for the source and P₁ is the load pressure response.

According to one embodiment, the Thevenin equivalent may be determined by a processor 120 of the wearable device 100 and configured to receive and process a measurement of the sound wave signal received by the IEM 106.

The calculation of the Thevenin equivalent of the loudspeakers 210 (108a or 108b) generally comprises using metal tubes as calibration cavities to measure the pressure (P) 212, calculating the ideal expression of the cavity impedance Z_{c} 214 and estimating the Thevenin equivalent 216.

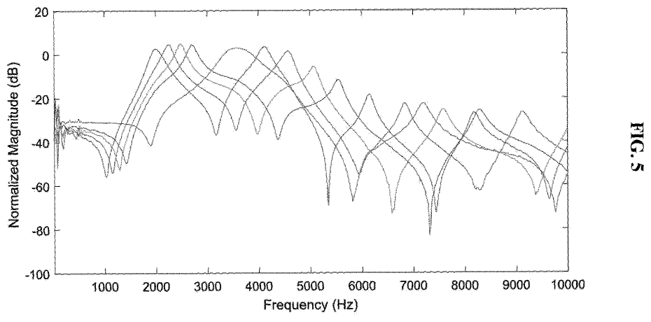

The calculation of the Thevenin equivalent of the probe loudspeaker impedance (Zₛ) may comprise or involve using a calibration device 150 to measure sound pressures (Pₘ) at different frequencies 212. The calibration device 150 comprises one or more metal tubes or pipes 160 of known lengths for specific resonance frequencies with a closed extremity at one end. The closed extremity is preferably a hard termination. In a preferred embodiment, a calibration device 150 comprises five (5) tubes 160. Said tubes 160 are generally used as calibration cavities. Selecting the lengths of the cavities generally depends on the number of cavities and the response of the probe loudspeaker (108a or 108b). Preferably, the cavity wavelengths are selected with minimal peak resonances and nulls overlap between cavities to cover a maximum range of the loudspeaker frequency response, as shown in FIG. 5.

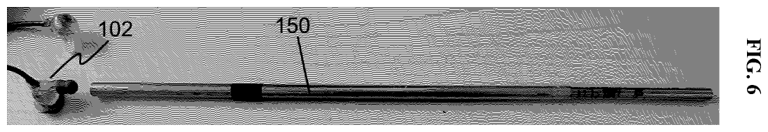

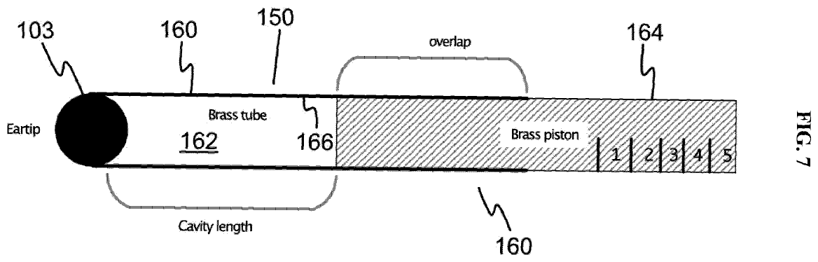

Referring now to FIGS. 6 and 7, an exemplary tube 160 of the calibration device 150 is illustrated. As discussed above, the tube 160 is separate from the wearable device 100 and is used to estimate the Thevenin equivalent of the internal loudspeakers 108. Broadly, the calibration device 160 comprises an internal acoustic cavity or chamber 162 having a variable volume or different volumes. The different volumes change the sound pressure level frequency response within the cavity 162 for a signal at a specific frequency. The sound pressure level may be measured at different frequencies or for a range of frequencies for each cavity volume.

According to certain embodiments, the calibration device 150 may comprise a plurality of resonating tubes 160, each having a different inner volume. The tube 160 generally has an inner diameter being similar or close to that of the inner diameter of an ear canal 102. Even if a tube 160 having a cylindrical shape is preferred, one skilled in the art shall understand that tubes 160 having other shapes may also be used.

In other embodiments, the tube 160 comprises a piston 164. In a preferred embodiment, the tube 160 has an effective inner diameter of 7.9 mm and the piston 164 has an outer diameter suitable to sealingly slide or to be snuggly fit along the inner surface 166 of the tube 160. A cavity within the calibration piping 160 may therefore be adjusted and may vary by sliding the piston 164 within the tubing 160. The tube 160 and the piston 164 may be made of any suitable material such as brass. In other embodiments, the tube 160 may be made of machined aluminum or any other suitable metal allowing for a snug fit between the tube 160 and the piston 164 while still permitting a relative motion between the two.

The ear tip 103 of the device 100 may be configured to be either partially or wholly inserted into one of the tubes 160 of the calibration device 150. In a preferred embodiment, the ear tip 103 is mounted within the tube 160 such as to create a seal thereby minimizing sound leakage. Configured in this manner, sounds emitted by the internal loudspeakers 108 resonate within one of the tubes 160 of the calibration device 150.

The calculation of the ideal expression for the cavity impedance Z_{c} 214 generally uses the following equation:

Z_{c}=—iZ₀cot(kL),

where Z₀ is the characteristic impedance of a plane wave propagating in the tube 160, L is the length of the cavity and k is the wave number.

The characteristic impedance is preferably calculated as follows:

$${Z}_{0} = \frac{ρ c}{A}$$

where ρ is the density of air, c is the speed of sound, and A is cross-sectional area of the tube 160.

The density of air (ρ) and the speed of sound (c) generally depend on environmental conditions. Such constants may be approximated as a function of the temperature in the cavity. The temperature may be measured in the cavity using an infrared temperature sensor. To ensure optimal precision in the Thevenin equivalent and the resulting FPL estimate, the measurements of the pressure and of the temperature in the cavity shall be performed on the same day or within a few hours of the in-ear calibration procedure.

The Thevenin equivalent is estimated 216 by solving Pₛ and Zₛ in the following equation for each frequency:

$$[ \begin{matrix}{Z}_{c 1} & - {P}_{1} \\ {Z}_{c 2} & - {P}_{2} \\ ⋮ & ⋮ \\ {Z}_{cm} & - {P}_{m}\end{matrix} ] [ \begin{matrix}{P}_{s} \\ {Z}_{s}\end{matrix} ] = [ \begin{matrix}{Z}_{c 1} {P}_{1} \\ {Z}_{c 2} {P}_{2} \\ ⋮ \\ {Z}_{cm} {P}_{m}\end{matrix} ]$$

where Z_{cm} is the m^{th} cavity's impedance as calculated above and Pₘ is the pressure measured in this cavity. Pₛ and Zₛ are the Thevenin equivalents for the source pressure and source impedance, respectively.

The method 200 further comprises calculating the load impedance Z₁ using the estimated Thevenin equivalent impedance Zₛ 220. The load impedance is the ear canal impedance measured at the reference plane in the ear canal. The calculation of the load impedance Z₁ 220 generally comprises measuring the sound pressure (P₁) in the ear canal of a user 222 and calculating Z₁ 224 using the following equation:

$${Z}_{l} = \frac{{Z}_{s} {P}_{l}}{{P}_{s} - {P}_{l}}$$

For the sake of clarity, the tubes 160 are used only for estimating the Thevenin equivalent 216. The sound pressure (P₁) is measured using the IEM 106 positioned in the ear canal. Based on the measured value of P₁, the load impedance Z₁ may be calculated 220.

The method to estimate the FPL further comprises calculating the estimated pressure level emitted by the loudspeaker 108 in the ear canal (P_{forward}) 230 using the following equation:

$${P}_{forward} = \frac{1}{2} {P}_{l} ( 1 + \frac{{Z}_{0}}{{Z}_{l}} )$$

where P₁ is the load's pressure (i.e. the total sound pressure) in the ear canal 12, and Z₁ is the load impedance determined by both resistive and reactive elements, both P₁ and Z₁ are frequency-specific.

Referring back to FIG. 2, the P_{forward} value represents the component 192 moving toward the cochlea while the P₁ pressure level represents the combination of the component 192 moving toward the cochlea and the component 194 moving toward the entrance of the ear canal.

The P_{forward} value is used to calculate a correction value 240 to be applied on the loudspeaker 108. In some embodiments, the calibration is performed using a gain table. As such, for a specific stimuli frequency, the correction is calculated by finding the difference between a desired value of pressure and the P_{forward} value at the specific frequency of the gain table.

An exemplary gain table for a correction calculation of different frequencies is presented below:

| f₁ | Correction | f₂ | Correction |
|---|---|---|---|
| (Hz) | (dB) | (Hz) | (dB) |
| 5057 | −2.7 | 6169 | −4.5 |
| 4637 | 0.8 | 5657 | 1.0 |
| 4252 | 0.4 | 5187 | −2.6 |
| 3899 | 3.0 | 4757 | −3.2 |
| 3575 | 5.0 | 4362 | −2.0 |
| 3279 | 7.8 | 4000 | 1.0 |
| 3007 | 11.6 | 3668 | 4.0 |
| 2757 | 9.0 | 3364 | 6.0 |
| 2528 | 5.0 | 3084 | 8.0 |
| 2318 | 4.0 | 2828 | 10.0 |
| 2126 | 4.0 | 2594 | 7.0 |
| 1949 | 4.0 | 2378 | 3.0 |
| 1788 | 6.0 | 2181 | 2.0 |
| 1639 | 6.0 | 2000 | 4.0 |
| 1503 | 4.0 | 1834 | 5.0 |
| 1379 | 3.0 | 1682 | 7.0 |
| 1264 | 3.0 | 1542 | 6.0 |
| 1159 | 3.0 | 1414 | 5.0 |
| 1063 | 4.0 | 1297 | 4.0 |
| 975 | 4.0 | 1189 | 3.0 |
| 894 | 4.0 | 1091 | 4.0 |
| 820 | 5.0 | 1000 | 4.0 |

The FPL calibration method generally requires different steps, e.g. measuring the pressure in all five cavities, and specific hardware (e.g. special probe design and high quality sound card) to minimize the distortion in the Thevenin estimate.

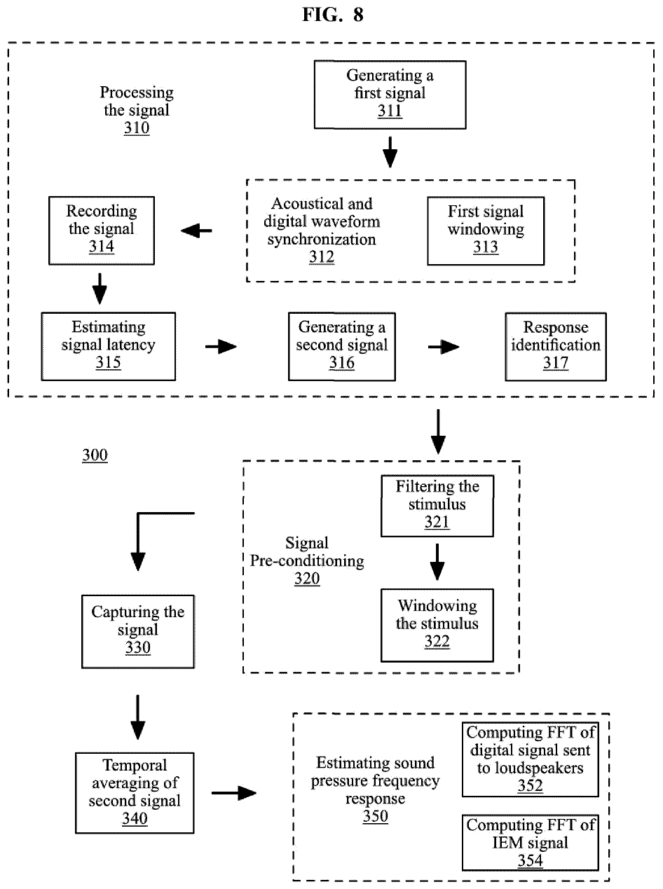

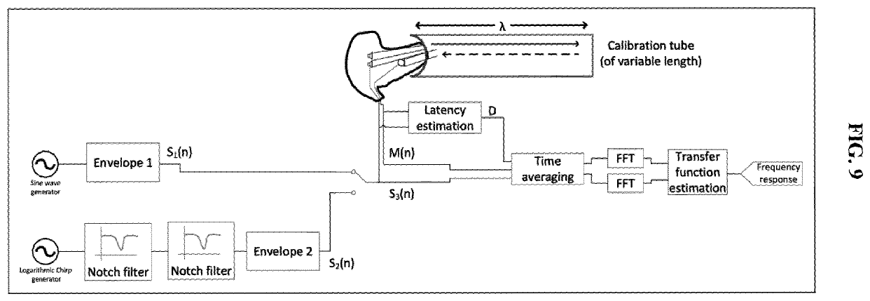

Referring now to FIGS. 8 and 9, in some embodiments, a method to estimate the Thevenin equivalent of the loudspeaker 108, 300 is provided. Such method 300 generally aims at minimizing the signal distortion to calculate the Thevenin equivalent and at reducing the dynamic range necessary for the IEM 106 signal of the device 100. The method generally comprises generating and processing the signals 310, pre-conditioning the signal 320, capturing the signal 330 using the IEM 106 and estimating the sound pressure frequency response 350.

The processing of the signal 310 comprises generating a first signal 311, preferably a sine wave signal. The processing 310 may further comprises synchronizing the acoustical and digital waveforms 312, such as using the first two cycles of the first stimulus signal. Synchronization is typically required to account for a small delay between the generation of the first signal 311 through the miniature loudspeakers 108 and recording of the signal 314 by the IEM 106. The synchronization 312 may further comprise windowing the first signal with a first envelop (i.e. Envelop 1) 313, such as using a 3 kHz sine wave windowed with Envelop 1 as shown in FIG. 9. The envelope generally helps to reduce the generation of harmonics, i.e. ringing, caused by a fast zero-crossing and also to enhance the latency estimation. This sine wave frequency is typically chosen for all cavity lengths of the tube 160 to minimize possible constructive interference due to the reflected wave in the occluded cavity.

The processing 310 further comprises estimating the latency of the signal 315. The estimation of the latency 315 is typically performed using the cross-correlation between the first (digital) stimulus signal and the captured signal with the IEM 106. This latency is compensated using a delay (D) in the time averaging algorithm, as shown in FIG. 9, for estimating the cavity frequency response.

The processing 310 further comprises generating a second signal 316, such as a logarithmic chirp signal. The processing further comprises identifying the response in the cavities 317 of the tube 160 using the second signal. The identification of the response 317 generally aims at minimizing the distortion in the wideband frequency response, maximizing the high frequency response and/or compensating for the loudspeaker 108 roll-off. Preferably, the identification of the responses 317 uses a predetermined number of cycles following the synchronization cycles, such as using the 10 cycles following the 2 synchronization cycles.

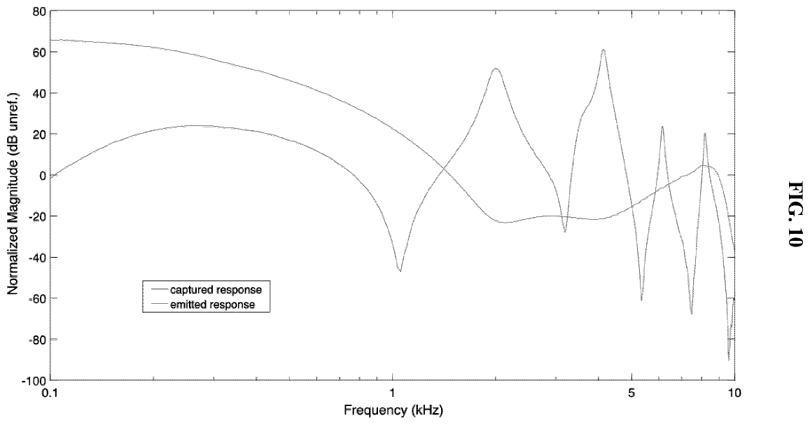

The method 300 further comprises pre-conditioning the second signal 320. The preconditioning 320 comprises filtering 321 and windowing 322 the second signal emitted by the loudspeaker 108. The filtering 321 and windowing 322 generally aims at ensuring that the acoustical signal magnitude of the occluded cavity and the resonance's peaks do not saturate the recorded IEM signal, and ensure the resonance's nulls are above the recording system's noise floor for optimal dynamic range. The filtering 321 may comprise applying one or two Infinite Impulse Response (IIR) notch filters in series on the second signal. Preferably, the notch filters have central frequencies at the first harmonics of the selected cavities' resonance frequencies, which are estimated with the acoustical lengths of wavelength λ. As an example, if the central frequency is set to f_{cla}≈2 kHz for the first notch filter and f_{clb}≈4.2 kHz for the second notch filter of the first cavity, as shown in the emitted response in FIG. 10. The windowing of the second signal 322 may comprise using a fade-in/fade-out function envelope (Envelope 2) over the first predetermined number of samples and the last predetermined number of samples of each cycle, such as but not limited to the first and last ≈50 samples.

The method 300 further comprises capturing the signal M(n) 330 in the tube 160 using the IEM 106.

The processing of the signal 310 further comprises performing temporal averaging of the second signal 340. To average the second signal, the temporal averaging starts at the sample index indicated by the latency D plus the number of synchronization cycles.

The method 300 further comprises calculating the sound pressure frequency response 350. The calculation of the sound pressure frequency 350 typically comprises computing a Fast Fourier Transform (FFT) on the digital signal sent to the loudspeakers S₃(n) 352 and on the captured IEM signal M(n) 354. The calculation of the sound pressure frequency response 350 further comprises computing the ratio of the two FFTs using a transfer function estimation 346.

The two signals may comprise a white noise or a chirp, i.e. sine sweep signal, having frequencies between the range of 10 Hz and 20,000 Hz or any other suitable frequency range. In some embodiments, the white noise or the chirp may have a duration of about 10 seconds or any other duration that is sufficient for allowing the processor to determine the transfer function.

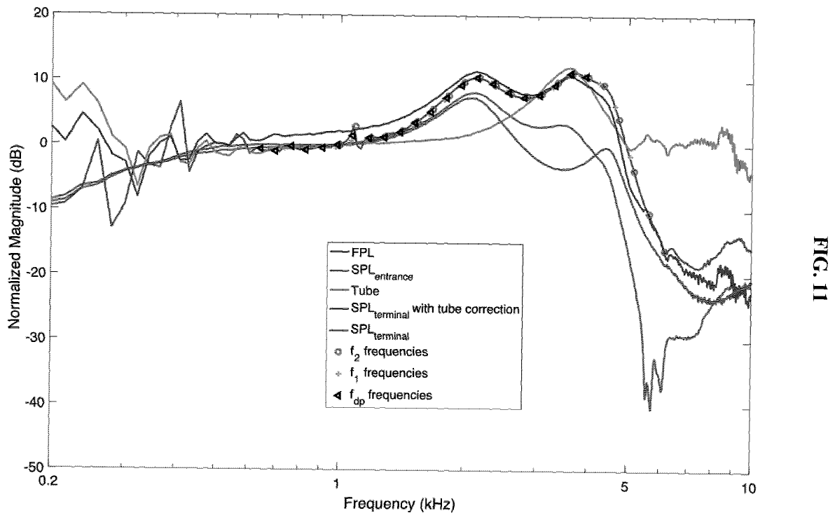

FIG. 11 illustrates comparative test results illustrating the magnitude of the captured frequency responses obtained using an OAE measurement probe. As shown in FIG. 11, a substantial agreement can be identified between the forward pressure obtained using the above-specified method (represented by FPL) and sound pressure level at the opposite extremity of the cavity 160 representing the tympanic membrane 14 (represented by SPLtemnnal with tube correction). Moreover, these values deviate from the actual measurements captured at the reference plane 107 i.e. the entrance of the calibrating tube 152 (represented by SPLentrance)

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A method to calibrate an earpiece, the method comprising:
calculating the Thevenin equivalent impedance of at least one loudspeaker;
calculating the load impedance at a reference plane in the ear canal as a function of the estimated Thevenin equivalent impedance;
estimating forward pressure (P_{forward}) emitted by the loudspeaker at the reference plane based on the calculated load impedance and on the measured sound pressure level; and
calculating a correction value to be applied on the loudspeaker based on the estimated forward pressure level.

2. The method of claim 1, the calculation of the Thevenin equivalent further comprising calculating the Thevenin equivalent impedance (Zₛ) and sound pressure (Pₛ).

3. The method of claim 2, the calculation of the load impedance further comprising measuring a sound pressure (P₁) in the ear canal at the reference plane and calculating the impedance (Z₁) at the reference plane using the following equation:
$${Z}_{l} = \frac{{Z}_{s} {P}_{l}}{{P}_{s} - {P}_{l}} .$$

4. The method of claim 3, the estimation of the estimated pressure level emitted by the loudspeaker using the following equation:
$${P}_{forward} = \frac{1}{2} {P}_{l} ( 1 + \frac{{Z}_{0}}{{Z}_{l}} ) .$$

5. The method of claim 1, the calculation of the correction value to be applied on the loudspeaker further comprising using a gain table.

6. The method of claim 5, the calculation of the correction value to be applied further comprising finding difference between a desired sound pressure level and the P fonvard value at a specific frequency in the gain table.

7. A method to estimate the Thevenin equivalent of a loudspeaker, the method comprising:
using a calibration device having a cavity to measure sound pressure (P) at different frequencies;
calculating an ideal expression of the cavity impedance (Z_{c}); and
estimating the Thevenin equivalent based on the calculated ideal expression of the cavity impedance.

8. The method to estimate the Thevenin equivalent of a loudspeaker of claim 7, the calculation of the ideal expression of the cavity impedance (Z_{c}) further comprising:
generating first and second stimulus signals;
processing the first signal;
pre-conditioning the second signal;
alternatively emitting the first and second signals in a calibration tube of the calibration device;
capturing the sound pressure in the calibration tube using an in-ear microphone (IEM);
estimating the sound pressure frequency response based on the captured IEM signal.

9. The method of claim 8, the first signal being a sine wave signal.

10. The method of claim 8, the processing of the first signal further comprising synchronizing the acoustical and digital waveforms of the first signal.

11. The method of claim 10, synchronizing the first signal further comprising windowing the first signal with a first envelop.

12. The method of claim 8, the processing of the first signal further comprising estimating the latency of the first signal.

13. The method of claim 12, the method further comprising performing temporal averaging of the second signal starting at a sample index defined by the latency of the first signal.

14. The method of claim 8, the second signal being a logarithmic chirp signal or any wide-band stimulus signal.

15. The method of claim 8, the pre-conditioning of the second signal further comprising filtering the second signal.

16. The method of claim 15, the filtering further comprising applying one or two Infinite Impulse Response (IIR) notch filters in series on the second signal.

17. The method of claim 8, the pre-conditioning of the second signal further comprising windowing the second signal.

18. The method of claim 17, the windowing further comprising using a fade-in/fade-out function envelope over a first predetermined number of samples and a last predetermined number of samples of each cycle.

19. The method of claim 8, the method further comprising performing temporal averaging of the second signal.

20. The method of claim 8, the estimation of the sound pressure frequency response comprising computing a Fast Fourier Transform (FFT) on the preprocessed (digital) signal sent to the loudspeakers and on the captured IEM signal.

21. The method of claim 8, the estimating of the sound pressure frequency response further comprising computing a ratio of the two computed FFTs using a transfer function.

22. A calibration device to estimate Thevenin equivalent of a loudspeaker, the calibration device comprising:
a loudspeaker being configured to generate two stimulus signals;
a cavity having a variable volume;
a capturing device to measure the sound pressure emitted by the loudspeaker in the cavity;
a signal preprocessor connected to the loudspeaker, the signal processor being adapted to process the stimulus signals;
a signal selector to emit one of the two stimulus signals in the cavity;
a signal postprocessor connected to the capturing device and configured to estimate the cavity frequency response based on the captured sound pressure.

23. The calibration device of claim 22, the calibration device further comprising a slidable piston to vary the volume of the cavity.

24. The calibration device of claim 22, the capturing device being an in-ear microphone.

25. The calibration device of claim 22, the preprocessor comprising one or two Infinite Impulse Response (IIR) notch filters in series and configured to filter the second stimulus signal.

26. The calibration device of claim 22, the preprocessor comprising a fade-in/fade-out function envelope over a first predetermined number of samples and a last predetermined number of samples of each cycle.

27. The calibration device of claim 22 further comprising a latency estimator connected to the preprocessed stimulus signal and to the captured signal.

28. The calibration device of claim 22, the postprocessor being configured to compute a Fast Fourier Transform (FFT) on the preprocessed (digital) signal sent to the loudspeakers and on the captured IEM signal.

29. The calibration device of claim 22, the postprocessor being configured to compute a ratio of the two computed FFTs using a transfer function estimation.

30. The calibration device of claim 22, the cavity being a metal tube.

31. The calibration device of claim 30, the calibration device comprising five (5) metal tubes having different lengths.

32. The calibration device of claim 30, the metal tube being made of brass.
